(19) United States
(12) Patent Application Publication
(10) Pub. No.: US 2022/0325718 A1
(43) Pub. Date: Oct. 13, 2022

(54) TURBOMOLECULAR VACUUM PUMP

(71) Applicant: PFEIFFER VACUUM, Annecy (FR)

(72) Inventors: Hisanori KAMBARA, Annecy (FR); Nicolas VARENNES, Annecy (FR); Gilles RICHIER, Annecy (FR)

(73) Assignee: PFEIFFER VACUUM, Annecy (FR)

(21) Appl. No.: 17/642,543

(22) PCT Filed: Sep. 24, 2020
(86) PCT No.: PCT/EP2020/076796

§ 371 Date: Mar. 11, 2022

(30) Foreign Application Priority Data
Oct. 3, 2019 (FR) 1910941

(51) Int. Cl. F04D 19/04; F04D 29/70

(52) U.S. Cl. CPC F04D 19/042; F04D 29/701

(57) ABSTRACT

A turbomolecular vacuum pump is provided, including: a stator; a rotor configured to rotate in the stator about an axis of rotation; and a regulation valve configured to modify an inlet conductance of the turbomolecular vacuum pump by axial displacement towards or away from a suction orifice of the turbomolecular vacuum pump, a face of the regulation valve facing the suction orifice having a hollow form.

The present invention relates to a turbomolecular vacuum pump, in particular for pumping an enclosure for manufacturing semiconductor components whose pressure is controlled by means of a regulation valve.

The generation of a high vacuum in an enclosure requires the use of vacuum pumps of turbomolecular type, composed of a stator in which a rotor is driven in rapid rotation, for example a rotation at more than ninety thousand revolutions per minute.

Turbomolecular vacuum pumps are notably employed in semiconductor component fabrication processes, to maintain a high vacuum in enclosures in a very clean environment, as free of particles as possible. Indeed, the particles in suspension in the atmosphere or produced by the processes taking place in the enclosure can hamper the production of the electronic circuits on the silicon wafers. It is therefore essential to limit the particle concentration to a very low threshold in the enclosure to guarantee a good productivity. This is all the more important as the fineness of the geometries of the fabricated products continues to diminish.

To control the pressure inside these enclosures, use is generally made of a regulation valve with variable conductance called “pendulum” valve, arranged at the suction side of the turbomolecular vacuum pump. The flat disc of the valve is displaced in a plane parallel to the inlet of the vacuum pump, thus more or less covering the inlet surface of the vacuum pump. The degree of opening of the valve makes it possible to vary the pumped flow and therefore the pressure in the enclosure. However, the movements of the valve in its casing can generate friction, notably at the seals, potentially constituting sources of particle formation.

These particles generated by the valve or by the process taking place in the enclosure can be struck by the blades of the turbomolecular vacuum pump rotating at high speed instead of being sucked and driven to the discharge. The particles can then bounce back on the blades and return into the enclosure where they can contaminate the silicon wafers on which the electronic circuits are produced.

Some turbomolecular vacuum pumps are known to include an integrated regulation valve. In these devices, the valve can be actuated axially towards and away from the suction orifice of the pump. Compared to the pendulum valves, these devices offer the advantage of discharging the pumped flow more uniformly into the enclosure, of not reducing the conductance in open position and of generating less particles. Indeed, the friction surfaces of the integrated valve are reduced compared to the disc sliding in the casing of a pendulum valve. Furthermore, the integrated valve that can be displaced axially facing the inlet orifice forms a screen that makes it possible to reduce the return of the particles into the enclosure by bouncing on the blades of the turbomolecular vacuum pump.

One of the aims of the present invention is to propose a turbomolecular vacuum pump that can improve the pumping of the particles in an enclosure in which the pressure is controlled by a regulation valve, notably a semiconductor component fabrication enclosure.

To this end, the subject of the invention is a turbomolecular vacuum pump comprising a stator, a rotor configured to rotate in the stator about an axis of rotation and a regulation valve configured to modify the inlet conductance of said vacuum pump by axial displacement towards or away from a suction orifice of said vacuum pump, characterized in that the face of the regulation valve facing the suction orifice has a hollow form.

With a face of the regulation valve situated facing the suction orifice having a hollow form, the particles struck by the radial blades of the vacuum pump that bounce on the regulation valve are mostly redirected towards the centre of the suction orifice. That reduces the probability of the particles returning into the enclosure.

Furthermore, the speed of displacement of the radial blades of the turbomolecular vacuum pump is proportional to the radial distance to the centre. By guiding the particles which bounce towards the axis of rotation, the kinetic energy of the particles is reduced, which reduces the probability of the multiple bounces.

The turbomolecular vacuum pump can have one or more features defined hereinbelow, taken alone or in combination.

The hollow form of the face is for example conical or concave.

According to an exemplary embodiment, only a periphery of the face is curved or inclined.

The angle of curvature of the face of the regulation valve is for example between 2° and 20°, such as between 5° and 10°.

The hollow face of the regulation valve can include a particle trap.

The stator can comprise an inlet annular flange situated on the side of the suction orifice with which the regulation valve is configured to cooperate to modify the inlet conductance and which is intended to be connected to an enclosure.

The internal wall of the inlet annular flange can have a flared form, of revolution about the axis of rotation.

The flared form of the internal wall of the inlet annular flange is for example tapered.

The angle of inclination of the internal wall is for example equal to the angle of curvature.

The angle of inclination of the internal wall is for example between 2° and 20°, such as between 5° and 10°.

The inlet annular flange can have a diameter of 150 mm or 350 mm.

The internal wall of the inlet annular flange can include a particle trap.

The turbomolecular vacuum pump can comprise at least one actuator situated outside the stator and configured to displace the regulation valve.

Other features and advantages of the invention will emerge from the following description, given by way of example, which is in no way limiting, in light of the attached drawings in which:

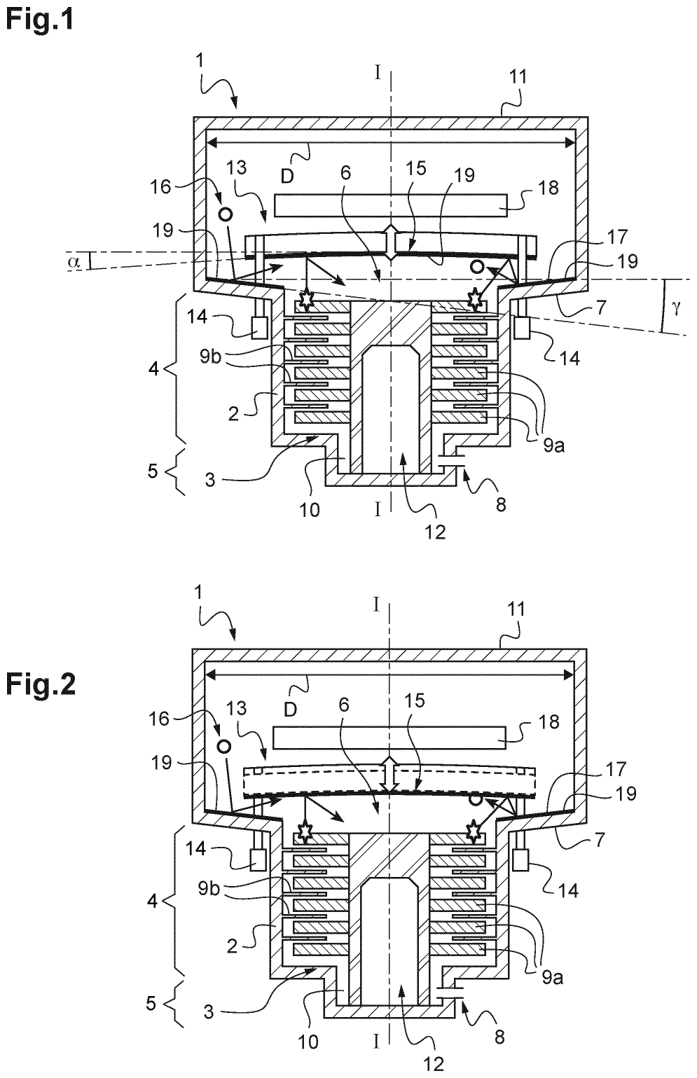

FIG. 1 shows a schematic axial cross-sectional view of an exemplary embodiment of a turbomolecular vacuum pump.

FIG. 2 shows a similar view of the turbomolecular vacuum pump of

FIG. 1 for another position of the regulation valve.

In these figures, the elements that are identical bear the same reference numbers.

The following embodiments are examples. Although the description refers to one or more embodiments, that does not necessarily mean that each reference relates to the same embodiment, or that the features apply only to a single embodiment. Simple features of different embodiments can also be combined or swapped to provide other embodiments.

FIGS. 1 and 2 illustrate an exemplary embodiment of a turbomolecular vacuum pump 1.

A turbomolecular vacuum pump 1 comprises, as is known per se, a stator 2 in which a rotor 3 rotates at high speed by axial rotation, about an axis of rotation I-I, for example a rotation at more than thirty thousand revolutions per minute, such as, for example, at more than ninety thousand revolutions per minute.

The turbomolecular vacuum pump 1 comprises a turbomolecular stage 4 and a molecular stage 5 situated downstream of the turbomolecular stage 4 in the direction of circulation of the pumped gases. The pumped gases flow first of all in the turbomolecular stage 4, then in the molecular stage 5, to be then discharged through a discharge orifice 8 of the vacuum pump 1.

The suction orifice 6 of the turbomolecular vacuum pump 1 through which the pumped gases enter is situated at the inlet of the turbomolecular stage 4. An inlet annular flange 7 for example encircles the suction orifice 6 to connect the vacuum pump 1 to an enclosure 11, such as a semiconductor enclosure intended to receive the silicon wafers on which electronic circuits are fabricated. A substrate-holder 18 of a semiconductor enclosure 11 is schematically represented in FIG. 1.

The rotor 3 here comprises, on the one hand, one or more stages of radial blades 9a which rotate facing fixed radial blades 9b of the stator 2 in the turbomolecular stage 4 and, on the other hand, a Holweck skirt 10 which rotates facing helical grooves of the stator 2 in the molecular stage 5.

The radial blades 9a, 9b of the rotor 3 and of the stator 2 are inclined to guide the pumped gas molecules to the molecular stage 5.

The Holweck skirt 10 is formed by a smooth cylinder. The helical grooves of the stator 2 make it possible to compress and guide the pumped gases to the discharge orifice 8.

The rotor 3 is driven in rotation in the stator 2 by an internal motor 12, for example arranged under the Holweck skirt 10. A purge gas can be injected into the vacuum pump 1 to purge and cool the discharge and/or the internal motor 12. The rotor 3 is guided laterally and axially by magnetic or mechanical bearings.

The rotor 3 is produced in a single piece (one-piece), for example in aluminium material. The stator 2 is for example made of aluminium material.

The turbomolecular vacuum pump 1 further comprises a regulation valve 13 configured to modify the inlet conductance of the vacuum pump 1 by axial displacement, that is to say displacement parallel to the axis of rotation I-I of the rotor 3, towards or away from the suction orifice 6 of the vacuum pump 1.

The regulation valve 13 has a disc form that can close the suction orifice 6 of the vacuum pump 1. The regulation valve 13 is for example configured to cooperate with the inlet annular flange 7 to modify the inlet conductance. An example of another positioning of the regulation valve 13 is schematically represented by dotted lines in FIG. 2.

This configuration of the regulation valve 13 notably makes it possible to bring the suction orifice 6 as close as possible to the internal volume of the enclosure 11. Furthermore, the regulation valve 13 that can be displaced axially facing the inlet orifice 6 forms a screen that makes it possible to reduce the return of the particles into the enclosure 11 through bounce on the blades of the vacuum pump 1.

According to an exemplary embodiment, the vacuum pump 1 further comprises at least one actuator 14 configured to displace the regulation valve 13. The at least one actuator 14 is for example situated outside the stator 2.

There are for example several actuators 14 evenly distributed around the inlet annular flange 7, such as two or four pairwise diametrically opposite actuators 14.

The actuators 14 situated outside the stator 2 and the regulation valve 13 that can be displaced axially notably make it possible to limit the phenomena of friction that can be the source of the formation of particles. The regulation valve 13 is also easy to dismantle for maintenance.

The face 15 of the regulation valve 13 situated facing the suction orifice 6 has a hollow form.

The hollow form of the face 15 is for example concave, that is to say curved over the entire face 15 with the apex of the hollow coinciding with the axis of rotation I-I.

According to another example, the hollow form of the face 15 is conical.

According to another example, only a periphery of the face 15 is curved or inclined, such as tapered, to form a face 15 having a hollow form, the centre of the face 15 being for example flat.

With a face 15 of the regulation valve 13 situated facing the suction orifice 6 having a hollow form, the particles 16 struck by the radial blades 9a of the vacuum pump 1 bouncing on the regulation valve 13 are mostly redirected towards the centre of the suction orifice 6. This reduces the probability of the particles 16 returning into the enclosure 11.

Furthermore, the speed of displacement of the radial blades 9a of the turbomolecular vacuum pump 1 is proportional to the radial distance to the centre. By guiding the particles 16 which bounce towards the axis of rotation I-I, the kinetic energy of the particles 16 is reduced, which reduces the probability of multiple bounces.

The angle of curvature α of the face 15 of the regulation valve 13, formed between a plane tangential to the apex of the hollow and a straight line passing through this apex and an edge of the face 15, is for example between 2° and 20°, such as between 5° and 10° (FIG. 1). This value of the angle of curvature α makes it possible to guide the particles 16 striking the face 15 of the regulation valve 13 towards the suction orifice 6 of the vacuum pump 1 in a typical semiconductor enclosure 11 geometry.

According to an exemplary embodiment, an internal wall 17 of the inlet annular flange 7 has a flared form, of revolution about the axis of rotation I-I, such as tapered. The funnel-form internal wall 17 guides the particles 16 which hit it towards the face 15 of the regulation valve 13, which itself guides the bounce of the particles towards the suction orifice 6 of the turbomolecular vacuum pump 1.

The angle of inclination γ of the tapered internal wall 17 is advantageously equal to the angle of curvature α. It is for example between 2° and 20°, such as between 5° and 10°. These values of the angle of inclination γ make it possible to guide the particles 16 striking the internal wall 17 towards the face 15 of the regulation valve 13 in a typical semiconductor enclosure 11 geometry.

Provision is for example also made for the diameter D of the inlet annular flange 7 to be 150 mm or 350 mm. The turbomolecular vacuum pump 1 thus has substantially the same diameter as that of a semiconductor enclosure 11 intended to receive the silicon wafers on which electronic circuits are fabricated. That makes it possible to limit the pumping capacity losses through the connections between the enclosure and the vacuum pump and to make the pumping uniform in the enclosure 11.

According to an exemplary embodiment, the hollow face 15 of the regulation valve 13 includes a particle trap 19. The particles can thus be adsorbed by the particle trap 19 or the contact with the particle trap 19 can make it possible to significantly reduce their kinetic energy.

The particle trap 19 comprises, for example, an adhesive coating at least partially covering a body of the regulation valve 13 for example made of metallic material, such as of aluminium. The hollow form is then defined by the body of the regulation valve 13, the adhesive coating following the form of the body.

According to another example, the particle trap 19 comprises a porous ceramic. In this case, the hollow form is defined by the porous ceramic and/or the body of the regulation valve 13.

Provision can be made for the internal wall 17 of the inlet annular flange 7 to include a particle trap 19.

As previously, the particle trap 19 comprises, for example, an adhesive coating at least partially covering a body of the inlet annular flange 7. The flared form of the internal wall 17 is then defined by the body of the inlet annular flange 7, the adhesive coating following the form of the body.

According to another example, the particle trap 19 comprises a porous ceramic. In this case, the flared form is defined by the porous ceramic and/or the body of the internal wall 17.

1.-14. (canceled)

15. A turbomolecular vacuum pump, comprising:
a stator;
a rotor configured to rotate in the stator about an axis of rotation; and
a regulation valve configured to modify an inlet conductance of the turbomolecular vacuum pump by axial displacement towards or away from a suction orifice of the turbomolecular vacuum pump,
wherein a face of the regulation valve facing the suction orifice has a hollow form.

16. The turbomolecular vacuum pump according to claim 15, wherein the hollow form of the face of the regulation valve is conical.

17. The turbomolecular vacuum pump according to claim 15, wherein the hollow form of the face of the regulation valve is concave.

18. The turbomolecular vacuum pump according to claim 15, wherein only a periphery of the face of the regulation valve is curved or inclined.

19. The turbomolecular vacuum pump according to claim 15, wherein an angle of curvature of the face of the regulation valve is between 2° and 20°.

20. The turbomolecular vacuum pump according to claim 15, wherein an angle of curvature of the face of the regulation valve is between 5° and 10°.

21. The turbomolecular vacuum pump according to claim 15, wherein the hollow face of the regulation valve includes a particle trap.

22. The turbomolecular vacuum pump according to claim 15, wherein the stator includes an inlet annular flange disposed on a side of the suction orifice with which the regulation valve is configured to cooperate to modify the inlet conductance and which is configured to be connected to an enclosure.

23. The turbomolecular vacuum pump according to claim 22, wherein an internal wall of the inlet annular flange has a flared form, of revolution about the axis of rotation.

24. The turbomolecular vacuum pump according to claim 23, wherein the flared form of the internal wall of the inlet annular flange is tapered.

25. The turbomolecular vacuum pump according to claim 23, wherein an angle of inclination of the internal wall is equal to an angle of curvature of the face of the regulation valve.

26. The turbomolecular vacuum pump according to claim 23, wherein an angle of inclination of the internal wall is between 2° and 20°.

27. The turbomolecular vacuum pump according to claim 23, wherein an angle of inclination of the internal wall is between 5° and 10°.

28. The turbomolecular vacuum pump according to claim 23, wherein the inlet annular flange has a diameter of 150 mm or 350 mm.

29. The turbomolecular vacuum pump according to claim 23, wherein the internal wall of the inlet annular flange includes a particle trap.

30. The turbomolecular vacuum pump according to claim 15, further comprising at least one actuator disposed outside the stator and configured to displace the regulation valve.
